(19) United States
(12) Patent Application Publication
(10) Pub. No.: US 2006/0136380 A1
(43) Pub. Date: Jun. 22, 2006

(54) System and method for executing a multi-table query

(76) Inventor: Terence Patrick Purcell, New Berlin, IL (US)

Correspondence Address: SAMUEL A. KASSATLY LAW OFFICE, 20690 VIEW OAKS WAY, SAN JOSE, CA, 95120, US

(21) Appl. No.: 11/015,939

(22) Filed: Dec. 17, 2004

(51) Int. Cl. G06F 17/30

(52) U.S. Cl. 707/3

(57) ABSTRACT

A multi-table query system utilizes indexes to provide filtering and then obtains the desired data. The multi-table query system reduces excessive data retrieval by minimizing access by multi-table joins to data pages until absolutely necessary in a process of executing the query. The multi-table query system improves runtime performance and minimizes a risk of poor performance if the optimizer of the DBMS incorrectly estimates the filtering and chooses a less than optimal table join sequence. The multi-table query system does not require the implementation of any additional indexing technology for the DBMS. Existing indexing technologies, such as the standard single table B-tree index design can exploit the multi-table query system.

### FIELD OF THE INVENTION

The present invention generally relates to database management systems, and in particular to queries on data managed by the database management systems. In specific, the present invention relates to reducing data access of a query when executing a query on more than one table in a database management system.

### BACKGROUND OF THE INVENTION

Databases are computerized information storage and retrieval systems. A Relational Database Management System (RDBMS) is a database management system (DBMS) that uses relational techniques for storing and retrieving data. Large enterprise application solutions typically use database management systems (DBMS) such as DB2®, Informix®, Oracle®, MS SQL Server®, and others to store and retrieve data. These database management systems are found in every aspect of society ranging from business sectors to government institutions. Because of the wide-ranging applications, the schemas for these solutions are frequently very complex, including tens of thousands of segments/tables and indexes or more.

RDBMS software using a Structured Query Language (SQL) interface is well known in the art. The SQL interface has evolved into a standard language for RDBMS software and has been adopted as such by both the American National Standards Organization (ANSI) and the International Standards Organization (ISO).

In RDBMS software, all data is externally structured into tables. The SQL interface allows users to formulate relational operations on the tables either interactively, in batch files, or embedded in host language, such as C, COBOL, etc. Operators are provided in SQL that allow the user to manipulate the data, wherein each operator operates on either one or more tables and produces a new table as a result. The power of SQL lies on its ability to link information from tables or views together to perform complex sets of procedures with a single statement.

One of the most common SQL queries executed by RDBMS software is the SELECT statement. In the SQL standard, the SELECT statement generally has the format: “SELECT<clause>FROM<clause>WHERE<clause>GROUP BY<clause>HAVING<clause>ORDER BY<clause>.” The clauses generally follow this sequence. Only the SELECT and FROM clauses are required; other clauses are optional.

Generally, the result of a SELECT statement is a subset of data retrieved by the RDBMS software from one or more existing tables stored in the relational database, wherein the FROM clause identifies the name of the table or tables from which data is being selected. The subset of data is treated as a new table, termed the result table. The WHERE clause determines which rows are returned in the result table. Generally, the WHERE clause contains a search condition that is to be satisfied by each row returned in the result table. The rows that meet the search condition form an intermediate set. The intermediate set is processed further according to specifications in the SELECT clause. The search condition typically comprises one or more predicates, each of which specifies a comparison between two values from certain columns, constants or correlated values. Predicates in the WHERE clause are typically connected by Boolean operators.

Another operation permitted by SQL is a JOIN operation, which concatenates horizontally all or parts of two or more tables to create a new resulting table. The JOIN operation is implied by naming more than one table in the FROM clause of a SELECT statement, although it may also be performed on the same table, as defined in the SQL standard operation named a self-join. The JOIN operation can be used to reduce the resulting table through filtering with respect to specified criteria. However, when filtering comes from more than one table in a multi-table SQL join, each table may require access to more data rows than necessary as compared to the final filtered result.

FIG. 1 illustrates a result of an exemplary conventional nested join in an exemplary relational database 100. The exemplary relational database 100 comprises a customer table 105, an address table 110, a customer table index 115, and an address table index 120. The customer table 105 comprises 300 million rows; the address table 110 comprises 350 million rows. A user wishes to find a set of customers in the exemplary relational database 100 with a last name of “Smith” living in a state “CA”. An exemplary nested loop join for locating this set of customers is as follows:

SELECT C.*, A.*
FROM CUSTOMER C, ADDRESS A
WHERE C.CUSTID = A.CUSTID
AND C.LASTNAME = ‘SMITH’
AMD A. STATE = ‘CA’

In the exemplary nested loop join, the statement “LASTNAME=“SMITH”” qualifies 5 million rows in the customer table 105 and the statement “STATE=“CA”” qualifies 25 million rows in the address table 110. As illustrated in FIG. 1, the nested loop join accesses the five million rows for “LASTNAME=“SMITH”” from the customer table 105 via a suitable index such as the customer table index 115. The nested loop join subsequently accesses the data rows in the customer table 105 corresponding to the customer table index 115. Each of the 5 million rows accessed is then joined to the address table 110 via an index such as the address table index 120 and a join column such as a customer ID. In the address table 110, the exemplary nested join filters the 5 million customers with last name of “Smith” to 300,000 qualifying rows with “STATE=CA”, producing a query result.

Although this technology has proven to be useful, it would be desirable to present additional improvements. The exemplary nested loop join initially retrieved 5 million data rows from the customer table 105; the exemplary nested loop join retrieved a final result of 300,000 rows. Consequently, the exemplary nested loop join unnecessarily retrieved 4.7 million extra data rows from the customer table 105. In this case, the filtering provided by any individual table is much larger than the final result set, requiring the join to provide significant filtering.

A nested loop join is able to apply only a local filtering to the first table accessed; the nested loop join can apply a combination of local and join filtering to subsequent tables. However, as the example of FIG. 1 demonstrates, the local filtering on the first table may result in retrieving significantly more rows than required.

A sort-merge join (also known as merge-scan join) can independently access index and data pages relevant to a local filtering for each table and then join/merge the result, as illustrated in FIG. 2. In the example of FIG. 2, 5 million rows are accessed from the customer table 105 via the customer table index 115. In the address table 110, 25 million rows are accessed via the address table index 120. The sort-merge join combines the results from the customer table 105 and the address table 110 to obtain 300,000 records as a query result. In this example, the sort-merge join retrieved 30 million rows to obtain 300,000 records. Consequently, the data retrieval requirements are excessive for the nested loop join and the sort-merge join. Excessive data retrieval consumes computational resources and reduces efficiency of the database management system. Excessive data retrieval further slows down the response of the database management system to queries.

Excessive data retrieval is further exacerbated as additional tables are added to a query comprising filtering that is spread out among many of the tables. Excessive data retrieval can occur if the join filtering is applied to a small number of tables in a join relationship that comprises many tables in between the filtered tables. For example, a five table join comprising filtering on the first and fifth tables accessed by the join exhibit excessive data retrieval.

In an effort to reduce excessive data retrieval in a join query, conventional database management systems have implemented a concept of “join indexes” that allow application of the local and join filtering to single index. Although this technology has proven to be useful, it would be desirable to present additional improvements. While this approach reduces the effect of excessive data retrieval, the database management system is required to accommodate this new type of index. Furthermore, a database administrator is required to design specific indexes for each potential join. These indexes can incur costly overhead when updates occur in the database management system.

What is therefore needed is a system, a computer program product, and an associated method for a executing a multi-table query that reduces excessive data retrieval without requiring implementation of additional indexing technology for the database management system. The need for such a solution has heretofore remained unsatisfied.

### SUMMARY OF THE INVENTION

The present invention satisfies this need, and presents a system, a computer program product, and an associated method (collectively referred to herein as “the system” or “the present system”) for executing a multi-table query. The present system utilizes indexes to provide filtering and then obtains the desired data. The present system reduces excessive data retrieval by minimizing access by multi-table joins to data pages until absolutely necessary in a process of executing the query. The present system improves runtime performance and minimizes a risk of poor performance if an optimizer of the database management system (DBMS) incorrectly estimates the filtering and chooses a less than optimal table join sequence.

This invention proposes index-only joins with access to data only when necessary. Data access can be completely deferred until the end of the query when all tables accessed by the query have been joined via indexes. A multi-table query can be a combination of index-only and index+data joins depending on where filtering occurs in the query or where additional non-indexed columns are retrieved for a join to a subsequent table. The present system accesses required data rows of any tables accessed by an index-only access only after a substantial percentage of the filtering in the query has occurred. This may occur before all tables in the query are joined.

Compared to conventional multi-table queries, the present system does not require the implementation of any additional indexing technology for the DBMS. Existing indexing technologies, such as the standard single table B-tree index design can exploit the present system.

In many situations, a database administrator can avoid creating any new indexes to implement the present system. Indexes created to support the current application environment may be adequate. If existing indexes do not provide a desired performance, the database administrator may choose to create additional indexes to further implement the present system.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of a conventional database management system illustrating a conventional nested loop join query;

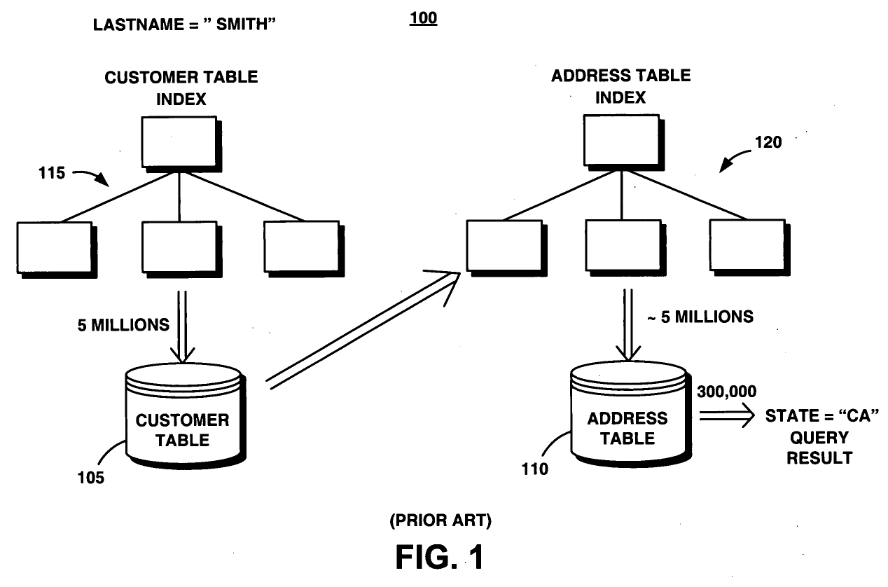

FIG. 2 is a schematic illustration of a conventional database management system illustrating a conventional sort-merge join query;

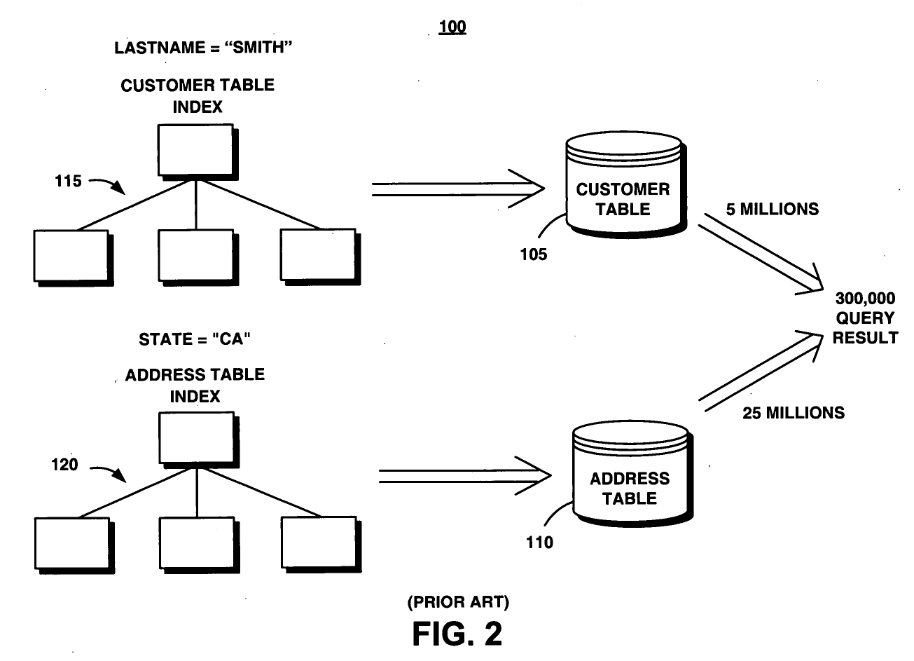

FIG. 3 is a schematic illustration of an exemplary operating environment in which a multi-table query system of the present invention can be used;

FIG. 4 is a schematic illustration of database management system illustrating a nested loop join—Index only join of the multi-table query system of FIG. 1;

FIG. 5 is a process flow chart illustrating a method of the multi-table query system of FIG. 1 in executing a query illustrated in FIG. 4;

FIG. 6 is a schematic illustration of a database management system further illustrating a nested loop join—index only join of the multi-table query system of FIG. 1; and

FIG. 7 is a process flow chart illustrating a method of the multi-table query system of FIG. 1 in optimizing a query by determining whether to perform indexonly access and deferred data access in the query.

### DETAILED DESCRIPTION OF PREFERRED EMBODIMENTS

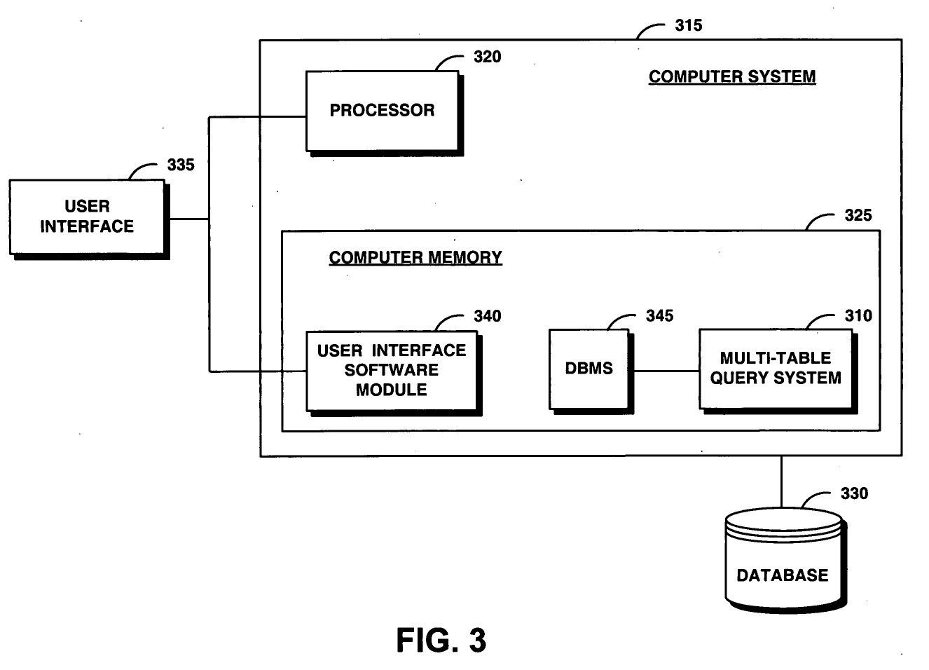

FIG. 3 portrays an exemplary overall environment in which a system and method for executing a multi-table query (the “system 3100” or “query module”) may be used. System 310 comprises a software programming code or a computer program product that is typically embedded within, or installed on a computer system 315. Alternatively, system 310 can be saved on a suitable storage medium such as a diskette, a CD, a hard drive, or like devices.

The computer system 315 comprises a processor 320 with a computer memory 325. The computer system 315 contains a database (dB) 330. The database 330 stores one or more relational databases and comprises one or more electronic storage devices such as, for example, disk drives. The disk drives may comprise, for example, optical disk drives, magnetic tapes or semiconductor memory. Each storage device further permits receipt of a computer program storage device, such as a magnetic media diskette, magnetic tape, optical disk, semiconductor memory and other machine-readable storage device, and allows for method program steps recorded on the program storage device to be read and transferred into the computer memory 325. Alternatively, the program steps can be received into the computer memory 325 from a computer over a network.

Operators of the computer system 315 use a user interface 335 with a-graphical user interface driven by a user interface software module 340 to transmit electrical signals to and from the computer system 315, that represent commands for performing various search and retrieval functions, termed queries, against the database 330. These queries conform to the Structured Query Language (SQL) standard, and invoke functions performed by a database management system (DBMS) 345. In one embodiment, the DBMS 345 comprises relational database management system (RDBMS) software. System 310 has application to any RDBMS software that uses SQL, and may similarly be applied to non-SQL queries.

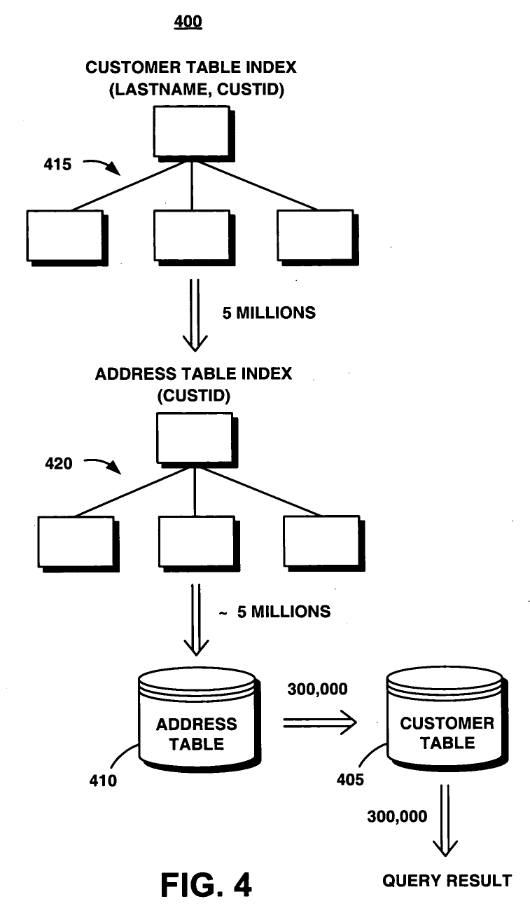

FIG. 4 is an illustration of a multi-table query of system 310 operating on an exemplary database management system 400. For illustration purposes only, database 400 comprises a customer table 405, an address table 410, a customer table index 415, and an address table index 420. The customer table index 415 exists on the customer table 405. The customer table index 415 comprises a column LASTNAME, corresponding to a last name for a customer, and a join column CUSTID, corresponding to a customer ID. The address table index 420 exists on the address table 410. The address table index 420 comprises a join column CUSTID, corresponding to the customer ID.

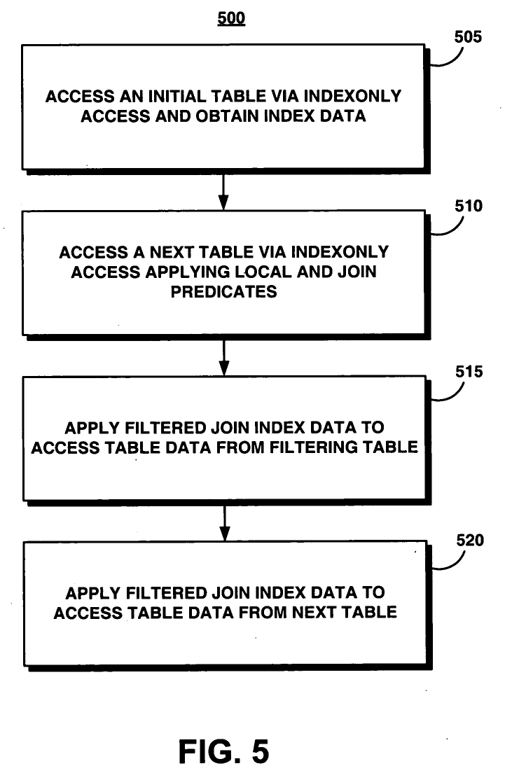

FIG. 5 illustrates a method 500 of system 310 in performing the exemplary query illustrated by the database management system 400 of FIG. 4. A user queries the database 400 using system 310 to locate all customers with last name “Smith” living in “CA”. System 310 accesses an initial table via access to the table index (referenced herein as indexonly access) to obtain index data (step 505). Access is via the customer table index 415, matching on LASTNAME=“SMITH”. An initial qualifying row is retrieved from the index. The initial qualifying row comprises the join column, CUSTID, and a record ID, RID. The record ID is used for data retrieval at a later stage.

System 310 accesses a next table via indexonly access using local and join predicates of the exemplary query (step 510) if available. In FIG. 4 however, an index only exists on the join predicate for the address table. The nested loop join—index only join of system 310 joins the initial qualifying row of the customer table index 415 to the address table 410 via the join column CUSTID in the address table index 420. System 310 applies filtered join index data to access table data from the address table (step 515). For each qualifying index entry from the address table index 420, system 310 retrieves the corresponding data row to compare a predicate STATE=“CA”, since this column is not in the index.

If the predicate does not qualify, system 310 discards the retrieved row in the address table 410. If the predicate qualifies, then system 310 accesses the corresponding data row in the customer table 405. In this example, system 10 retrieves only 300,000 rows from the customer table data 405 to find all customers with last name of Smith located in CA. In contrast, the conventional system previously described retrieved 5 million rows to locate similar information.

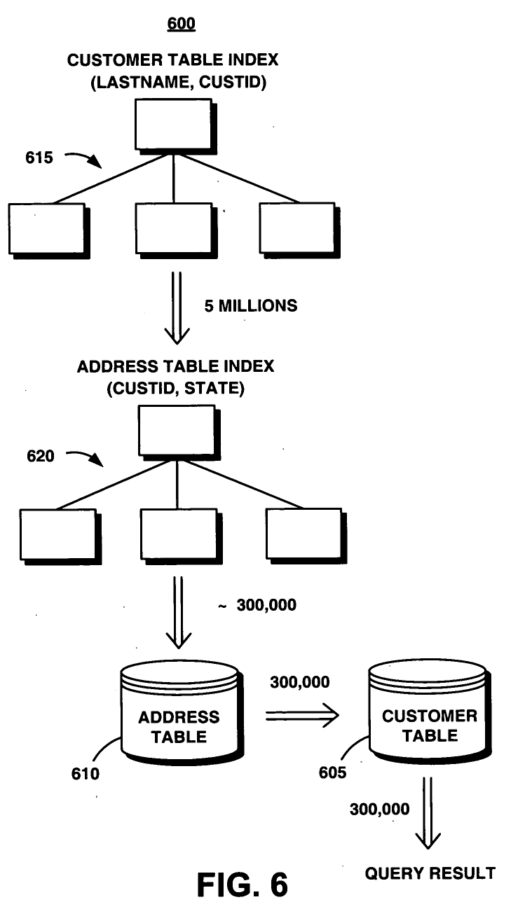

In one embodiment illustrated by an exemplary database management system 600 of FIG. 6, indexes in database management systems are generated to support queries of system 310 such as, for example, the local and join filtering query. As per FIG. 4, and index exists on the customer table comprising LASTNAME and CUSTID. For the address table, FIG. 6 contains an index comprising CUSTID and STATE (in either sequence). In this embodiment, data access is deferred on an initial table in the query. This embodiment further takes advantage of filtering from other indexes in the join of system 310 before accessing data in tables in the database management system 600.

For example, system 310 defers access to the customer table 605 until after accessing the address table 610. Filtering occurs in the customer table index 615 and the address table index 620. Consequently, either the address table 610 or the customer table 605 can be accessed after the index filtering has occurred. Alternatively, data in the address table 610 and the customer table 605 can be retrieved concurrently to further improve an elapsed time efficiency of system 310.

Standard SQL clauses such as, for example, OPTIMIZE FOR or FETCH FIRST, can be used to determine whether the query of system 310 fetches a small number of rows. If a small number of rows are to be fetched, system 310 performs data row access at the end of a join to all tables. This data row access is synchronous. Consequently, system 310 is not required to retrieve a subset based upon the clauses OPTIMIZE FOR or FETCH FIRST.

For access plans or queries expected to retrieve all qualifying rows, system 310 defers data access only until a majority of expected filtering has occurred. Data access may be mandatory for at least one of a set of outstanding tables, allowing system 310 to retrieve columns for a subsequent join where additional filtering is performed. For outstanding tables requiring data access, system 310 applies the following priority. System 310 confers higher priority to those tables for which additional filtering is to occur from predicates applied to the data pages. System 310 confers higher priority to those tables with the least number of distinct pages to be accessed. System 310 confers higher priority to those tables with a record ID (RID) list that is already in a clustering sequence. System 10 confers lower priority to those tables that significantly increase a length of a data row if a record ID (RID) sort for data access is required for any of the tables.

If a number of pages to be accesses by system 310 for a table is small (less than on the order of 8 pages), system 310 can execute the data access synchronously. If the number of pages to be accessed by system 310 for a table is higher (more than on the order of 8 pages), system 310 can sort the record into a record ID (RID) sequence for efficient data access (the record comprises table record IDs (RIDS) and concatenated columns from joined tables). System 310 repeats this sorting process for each table requiring data access.

System 310 provides filtering by local predicates, join predicates, partition elimination predicates, or some combination of these predicates. On occasion, not all table filtering is indexed. In this case, system 10 employs an optimizer cost decision to determine whether a non-indexed filtering is beneficial enough for data access to be immediate, or whether data access is deferred until filtering is applied from other tables or indexes.

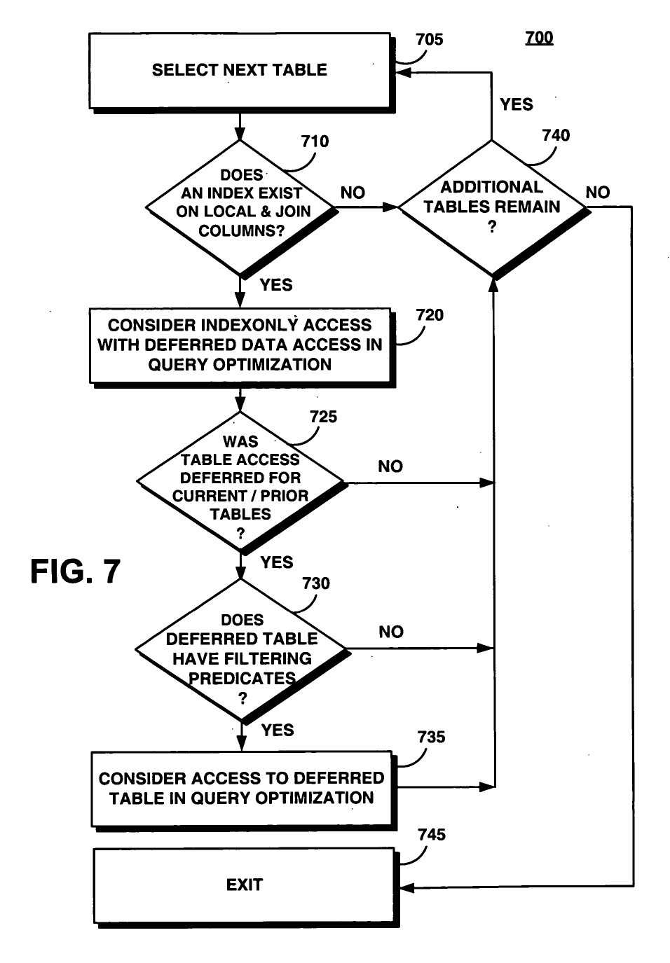

FIG. 7 illustrates a method 700 of system 310 in query optimization by determining whether to perform index only access and deferred data access in a query. System 310 selects an initial table for processing (step 705). System 310 determines whether an index exists on local and join columns of the selected table (decision step 710). If not, system 310 defers-to decision step 740. If yes, system 310 considers indexonly access with deferred data access in the query optimization (step 720). System 310 determines whether access is deferred for current or prior tables (decision step 725). If not, system 310 defers to decision step 740. If yes, system 310 determines whether the deferred table comprises filtering predicates (decision step 730). If not, system 310 defers to decision step 740. If yes, system 310 considers access to the deferred table in the query optimization (step 735). System 310 determines whether additional tables remain for processing (decision step 740). If yes, system 310 defers to decision step 740 and repeats step 705 through step 740. If not, system 310 exits method 700 (step 745).

It is to be understood that the specific embodiments of the invention that have been described are merely illustrative of certain applications of the principle of the present invention. Numerous modifications may be made to the system and method for executing a multi-table query described herein without departing from the spirit and scope of the present invention. Moreover, while the present invention is described for illustration purpose only in relation to SQL, it should be clear that the invention is applicable as well to, for example, any query language.

What is claimed is:

1. A method of executing a multi-table query, comprising:
executing the multi-table query beginning with an index of a first table, to apply a first filter, which is associated with the first table, to the query, and to retrieve index data from the first table;
applying the index data retrieved from the index of the first table to an index of a second table to access index data from the second table, resulting in join index data;
accessing any one of the first table or the second table with the join index data to generate an intermediate result set; and
accessing any one of the first table or the second table that has not been previously accessed with the intermediate result set, to generate a qualified result set.

2. The method of claim 1, wherein subsequent to applying the index data retrieved from the index of the first table, prioritizing access, with the resulting join index data, to the first table and the second table.

3. The method of claim 1, wherein prioritizing the access comprises determining which table provides additional filtering.

4. The method of claim 3, wherein accessing any one of the first table or the second table comprises accessing the table that provides additional filtering.

5. The method of claim 2, wherein prioritizing the access comprises conferring a higher priority to a table for which additional filtering occurs from predicates applied to data pages.

6. The method of claim 5, wherein conferring the higher priority comprises conferring the higher priority to the table with a least number of distinct pages to be accessed.

7. The method of claim 2, wherein prioritizing the access comprises conferring a higher priority to a table with a record identification list that is already in a clustering sequence.

8. The method of claim 7, wherein prioritizing the access comprises conferring a lower priority to a table that increase a length of a data row beyond a predetermined range.

9. The method of claim 1, wherein executing the multi-table query comprises more than two tables.

10. The method of claim 9, wherein the tables comprise a relational database.

11. A computer program product having a plurality of executable codes stored on a medium, for executing a multi-table query, comprising:
a first set of instruction codes for executing the multi-table query beginning with an index of a first table, to apply a first filter, which is associated with the first table, to the query, and to retrieve index data from the first table;
a second set of instruction codes for applying the index data retrieved from the index of the first table to an index of a second table to access index data from the second table, resulting in join index data;
a third set of instruction codes for accessing any one of the first table or the second table with the join index data to generate an intermediate result set; and
a fourth set of instruction codes for accessing any one of the first table or the second table that has not been previously accessed with the intermediate result set, to generate a qualified result set.

12. The computer program product of claim 11, wherein subsequent to the second set of instruction codes applying the index data retrieved from the index of the first table, a fifth set of instruction codes prioritizes access, with the resulting join index data, to the first table and the second table.

13. The computer program product of claim 11, wherein the fifth set of instruction codes prioritizes the access by determining which table provides additional filtering.

14. The computer program product of claim 13, wherein the third set of instruction codes accesses any one of the first table or the second table by accessing the table that provides additional filtering.

15. The computer program product of claim 12, wherein the fifth set of instruction codes prioritizes the access by conferring a higher priority to a table for which additional filtering occurs from predicates applied to data pages.

16. A system for executing a multi-table query, comprising:
a processor for executing the multi-table query beginning with an index of a first table, to apply a first filter, which is associated with the first table, to the query, and to retrieve index data from the first table;
for the processor further applies the index data retrieved from the index of the first table to an index of a second table to access index data from the second table, resulting in join index data;
a query module accesses any one of the first table or the second table with the join index data to generate an intermediate result set; and
the query module further accesses any one of the first table or the second table that has not been previously accessed with the intermediate result set, to generate a qualified result set.

17. The system of claim 16, wherein subsequent to the processor applying the index data retrieved from the index of the first table, the query module prioritizes access, with the resulting join index data, to the first table and the second table.

18. The system of claim 16, wherein the query module prioritizes the access by determining which table provides additional filtering.

19. The system of claim 18, wherein the query module accesses any one of the first table or the second table by accessing the table that provides additional filtering.

20. The system of claim 17, wherein the query module prioritizes the access by conferring a higher priority to a table for which additional filtering occurs from predicates applied to data pages.
